(19) United States
(12) Patent Application Publication
(10) Pub. No.: US 2011/0175927 A1
(43) Pub. Date: Jul. 21, 2011

(54) INFORMATION PROCESSING APPARATUS, METHOD OF OPERATION THEREOF AND STORAGE MEDIUM

(75) Inventor: Hiroki Urashima, Kawasaki-shi (JP)

(73) Assignee: CANON KABUSHIKI KAISHA, Tokyo (JP)

(21) Appl. No.: 12/958,011

(22) Filed: Dec. 1, 2010

(30) Foreign Application Priority Data
Jan. 18, 2010 (JP) 2010-008473
Nov. 24, 2010 (JP) 2010-261725

(51) Int. Cl. G09G 5/00

(52) U.S. Cl. 345/619

(57) ABSTRACT

The processing time including that for the process of expanding vector data representing each of a plurality of objects constituting an image into each object is acquired. The time taken to reproduce the image by using the vector data representing each of the plurality of objects is specified based on the acquired processing time. When the specified time exceeds a predetermined threshold, data, of the vector data representing the plurality of objects, which is to be converted into data in a raster format in advance is determined based on each acquired processing time, the specified time, and the predetermined threshold.

### BACKGROUND OF THE INVENTION

1. Field of the Invention

The present invention relates to an information processing apparatus which converts part of vector data representing a plurality of objects (graphics) constituting an image into data in a raster format, a method of operating the information processing apparatus, and a storage medium.

2. Description of the Related Art

Recently, images displayed on embedded equipment have increased in expressive power, and it is becoming common that moving images and highly expressive user interfaces (UIs) are displayed on the equipment. A vector image format is an image format that implements such moving images and UIs. A vector image is an image expressing the shapes of objects such as lines and surfaces by using numerical values. It is known that the data (vector data) of a vector image is smaller in data size than the data in a raster format (raster data) representing an equivalent image. It is also known that vector data can express various display effects and animation display. Note that display effects include, for example, feathering and drop shadow, and animation display includes, for example, enlargement/reduction and rotation.

If, however, vector data includes data expressing a display effect or animation display, it requires a relatively long period of time to expand each object with a set display effect or animation display from the vector data. For this reason, conventionally, vector data of an object requiring a relatively long time for expansion processing is converted into a data image in the raster format expressed by a set of pixels. When, however, vector data is converted into raster data, since the data size generally increases, it is necessary to carefully determine in advance which data, of vector data representing a plurality of objects constituting an image, is to be converted into raster data.

There is known a method of omitting the processing accompanying the rasterizing of an object for which a display effect is provided in rendering by rasterizing the object before the provision of the display effect for the object to shorten the processing time (for example, Japanese Patent Laid-Open No. 2008-015700).

The method proposed in Japanese Patent Laid-Open No. 2008-015700, however, does not rasterize data while gradation or a filter effect (for example, feathering or drop shadow), which takes a long period of time for processing, is applied to the data. It is therefore impossible to effectively shorten the processing time.

In consideration of the above problem, the present invention provides a technique of efficiently determining in advance which data, of vector data representing a plurality of objects constituting an image, is to be converted into a raster format in advance, in order to shorten the time required to expand each object from the data representing the image and reproduce the object.

### SUMMARY OF THE INVENTION

According to one aspect of the present invention, there is provided an information processing apparatus which processes vector data representing each of a plurality of objects constituting an image, the apparatus comprising: an acquisition unit adapted to acquire a processing time for processing including processing of expanding the vector data into each of the objects; a specifying unit adapted to specify a time taken to reproduce the image by using the vector data representing each of the plurality of objects, based on the processing time acquired by the acquisition unit; and a determination unit adapted to determine, when the time specified by the specifying unit exceeds a predetermined threshold, data, of the vector data representing the plurality of objects, which is to be converted into data in a raster format in advance, based on each processing time acquired by the acquisition unit, the time specified by the specifying unit, and the predetermined threshold.

Further features of the present invention will be apparent from the following description of exemplary embodiments with reference to the attached drawings.

### BRIEF DESCRIPTION OF THE DRAWINGS

FIG. 1A is a block diagram showing the arrangement of a vector image conversion apparatus according to the present invention;

FIG. 1B is a block diagram showing an example of a hardware arrangement according to the present invention;

FIG. 2 is a view showing an example of vector data according to the first embodiment;

FIGS. 3A to 3E are views each showing an example of a rendering result on vector data according to the first embodiment;

FIG. 4 is a view showing an example of a table indicating the information of each object in vector data according to the first embodiment;

FIG. 5 is a flowchart showing an overall processing procedure according to the first embodiment;

FIG. 6 is a flowchart showing the processing of vector data conversion into raster data according to the first embodiment;

FIG. 7 is a flowchart showing the processing of vector data conversion into raster data according to the second embodiment;

FIG. 8 is a flowchart showing the processing of vector data conversion into raster data according to the third embodiment;

FIG. 9 is a view showing an example of the data size of vector data and a threshold for the time required for image reproduction according to the first embodiment; and

FIGS. 10A to 10C are views each showing an example of the measured values of the data size of vector data and the time required for image reproduction according to the first embodiment.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

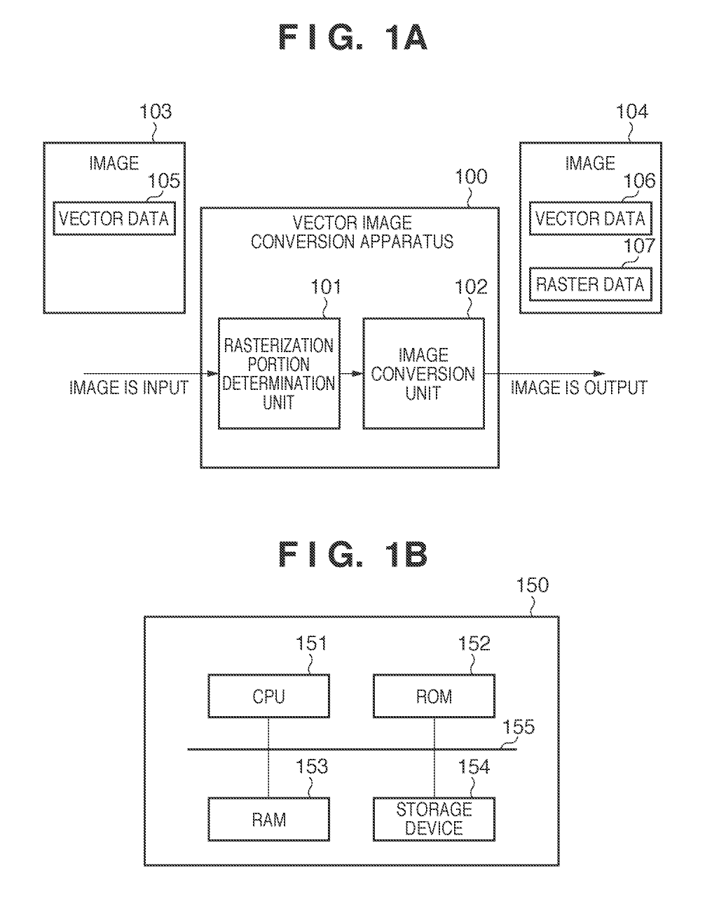

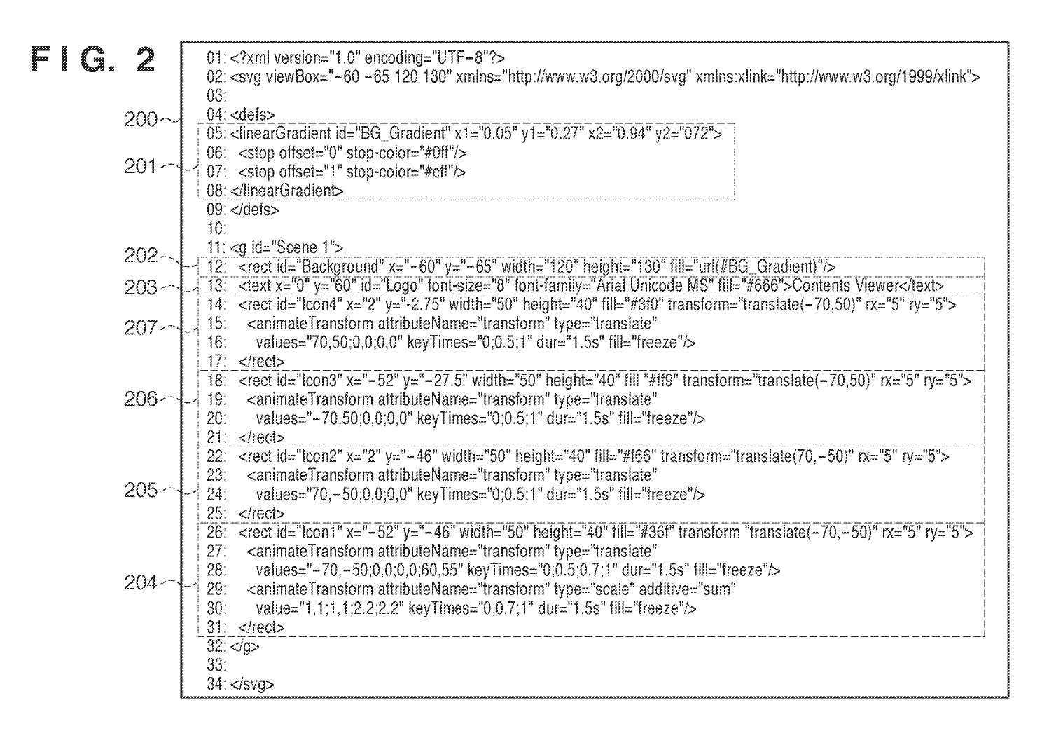

The arrangement of a vector image conversion apparatus (information processing apparatus) according to the present invention will be described with reference to FIG. 1A. A vector image conversion apparatus 100 according to the present invention includes a rasterization portion determination unit 101 and an image conversion unit 102. The vector image conversion apparatus 100 receives an image 103 including vector data 105. The vector image conversion apparatus 100 then outputs an image 104 including vector data 106 and raster data 107. The vector data 105 and the vector data 106 are data described in a vector format. Likewise, the raster data 107 is data described in a raster format. The rasterization portion determination unit 101 determines a portion, of the vector data 105 of the input image 103, which is to be converted into raster data. The image conversion unit 102 converts the portion determined by the rasterization portion determination unit into raster data, and outputs the image 104.

An example of the hardware arrangement of the vector image conversion apparatus according to the present invention will be described with reference to the block diagram of FIG. 1B. A CPU 151 performs computation, logical determination, and the like for various kinds of processing, and controls each component connected to a bus 155. The vector image conversion apparatus 100 is provided with a memory including a program memory and a data memory. The program memory stores programs for control by the CPU. The memory may be a ROM 152 or a RAM 153 in which a program is loaded from an external storage device. A storage device 154 includes a nonvolatile memory or hard disk for storing data and programs in advance. The vector image conversion apparatus 100 performs conversion processing for the image 103, image 104, and the like stored in the storage device 154.

An example of vector data of an image input to the vector image conversion apparatus 100 according to this embodiment will be described with reference to FIG. 2. In this case, vector data 200 is described by SVG which is one of the vector formats. However, the format of vector data is not specifically limited as long as it is a vector format. Vector data can be classified into the definition of an object and the definition of an effect applied to the object. Referring to FIG. 2, reference numerals 202, 203, 204, 205, 206, and 207 respectively denote the definitions of a plurality of objects; and 201, the definition of an effect applied to the object 202. These objects and the effect are assigned ID attributes added to the elements for the sake of convenience. Objects and effects will be referred to by using these names hereinafter. The objects 202, 203, 204, 205, 206, and 207 will be respectively referred to as Background, Logo, Icon1, Icon2, Icon3, and Icon4. The effect 201 will be referred to as BG_Gradient. Icon1, Icon2, Icon3, Icon4, and Background are defined by rect elements, and displayed as rectangles at the time of rendering. In addition, Logo is defined by a text element, and is displayed as a character string at the time of rendering. Of the objects, Icon1, Icon2, Icon3, and Icon4 are further added with animation definitions (for example, animateTransform element described on the 15th line in FIG. 2) which provide changes for the objects in accordance with the lapse of time. BG_Gradient 201 provides a description that gives a gradation effect to the painted portion of Background 202.

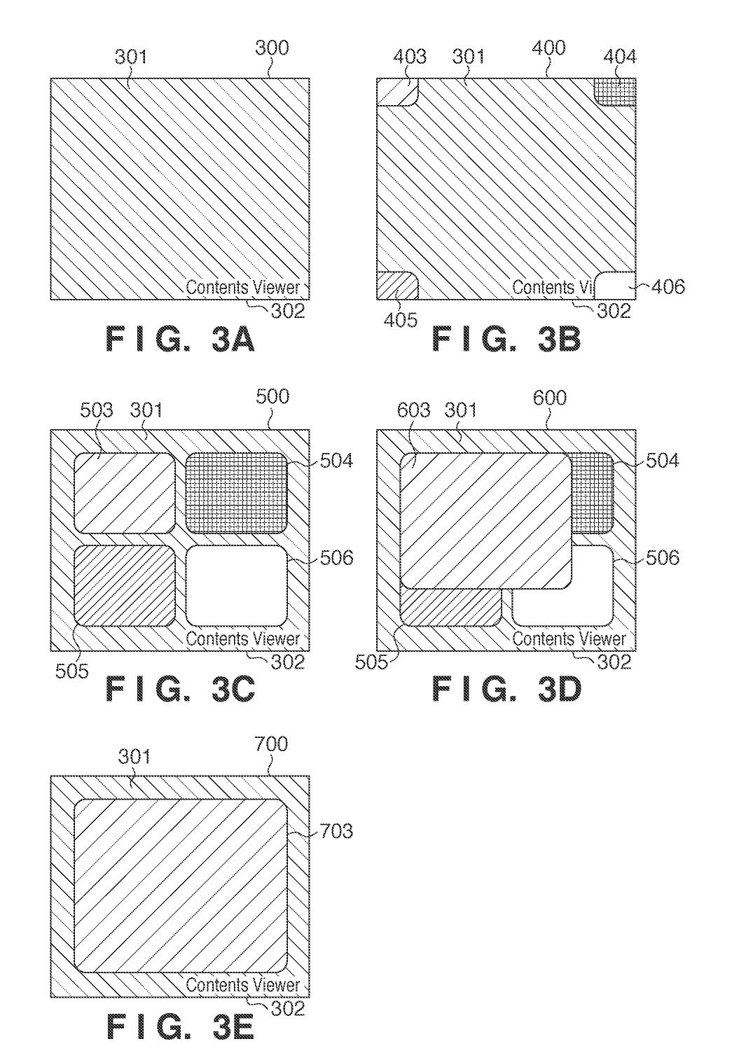

FIGS. 3A, 3B, 3C, 3D, and 3E respectively show the results obtained by rendering the vector data 200 in FIG. 2 after 0 sec, 0.2 sec, 1 sec, 1.3 sec, and 1.5 sec.

As shown in FIG. 3A, a rectangle 301 as the background of the rendering result after 0 sec corresponds to Background 202 defined by the vector data. A character string 302 corresponds to Logo 203. The rectangle 301 and the character string 302 shown in FIGS. 3B to 3E remain the same as those in FIG. 3A. As shown in FIG. 3B, rectangles 403, 404, 405, and 406 included in the rendering result after 0.2 sec respectively correspond to Icon1 204, Icon2 205, Icon3 206, and Icon4 207. These objects move from the display area of the screen and are rendered at the positions shown in FIG. 3B in 0.2 sec.

As shown in FIG. 3C, in the rendering result after 1 sec, Icon1, Icon2, Icon3, and Icon4 further move and are rendered at positions 503, 504, 505, and 506. Icon2, Icon3, and Icon4 stop moving at these positions. In the rendering result after 1.3 sec in FIG. 3D, Icon1 further moves from the position 503 to be enlarged and rendered at a position 603. In the rendering result after 1.5 sec in FIG. 3E, Icon1 keeps moving further from the position 603 and being enlarged. At a position 703, Icon1 stops moving and being enlarged and is rendered.

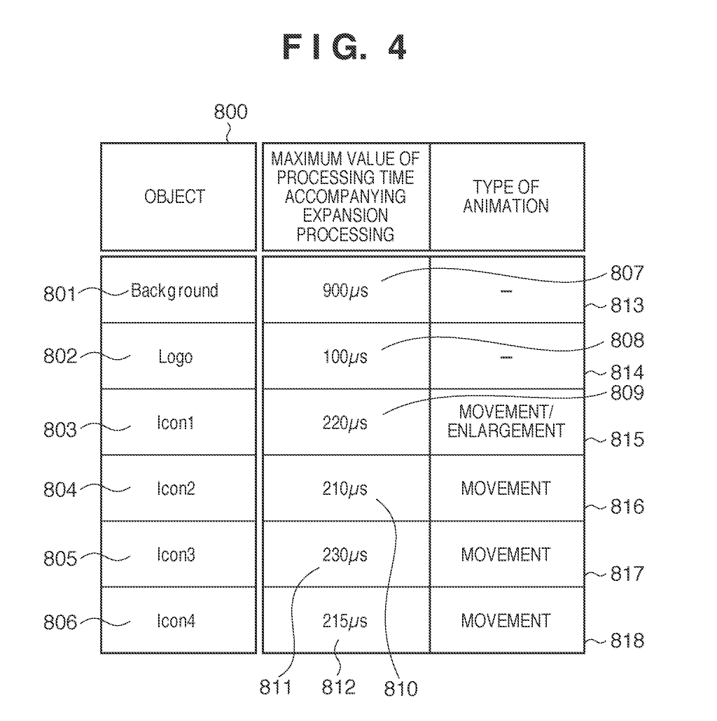

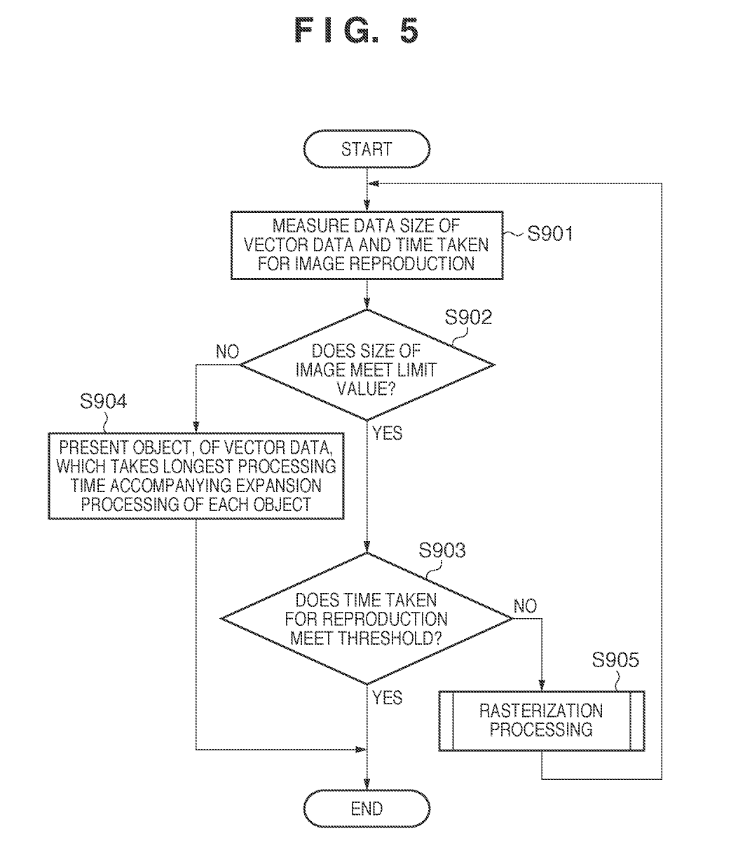

An example of an object information table will be described with reference to FIG. 4, which represents the maximum processing times accompanying the expansion of target objects in a plurality of frames from vector data representing the objects and the types of animations. In this case, a plurality of frames each indicate an image displayed on the screen when it is periodically updated, and each maximum processing time indicates the processing time for the frame which has taken the longest time for the processing accompanying expansion. Note that the processing times accompanying expansion are the times taken to convert the respective objects into objects in a state in which they can be displayed on a display or the like, and are acquired for the respective objects. The processing time may be the time between the instant at which vector data is read and the instant at which the corresponding object is converted into a state in which it can be displayed at a set position on a display or the like.

The processing times shown in FIG. 4 are calculated and acquired based on the vector data. Note that the RAM 153 stores information associated with the acquired processing times. In this case, reference numerals 801 to 806 respectively correspond to Background, Logo, Icon1, Icon2, Icon3, and Icon4 shown in FIG. 2.

Reference numerals 807 to 812 denote the maximum processing times per frame of the objects, which are acquired for the respective objects. Reference numerals 813 to 818 denote the types of animations which the respective objects perform. Background and Logo perform no animation, whereas Icon1 undergoes movement and enlargement, and Icon2, Icon3, and Icon4 undergo only movement.

FIG. 5 is a flowchart showing an example of a procedure for overall processing operation according to this embodiment. A procedure for conversion processing of the vector data 200 will be described with reference to this flowchart. In step S901, a CPU 151 specifies the time required for image reproduction processing by using the data size of vector data representing the image and the vector data. Note that the data size of the vector data is that of the vector size in a ROM or storage device storing the vector data. The time required for image reproduction processing is the time between the instant at which the image is rasterized and the instant at which the resultant data is written in a rendering buffer. That is, the time required for image reproduction processing is the time taken to reproduce the image by using vector data representing each of a plurality of objects constituting the image, and is specified based on the above processing time. Note that when equipment using the image reproduced from vector data differs from equipment to perform the vector image conversion processing of expanding the vector data into objects, the time required for image reproduction processing may be specified based on the data size of the vector data in the equipment using the image and the processing time. When equipment using an image is the same equipment which performs vector image conversion processing, the vector data may be converted in advance by vector image conversion processing or may be subjected to vector conversion processing immediately before the expansion of the vector data.

When vector data is to be converted immediately before the reproduction of an image, processing is performed in accordance with the execution state of the equipment. If, for example, a load is imposed on the equipment, the measured value of the processing time accompanying expansion processing increases. If no load is imposed on the equipment, the measured time of the processing time accompanying expansion processing decreases.

In step S902, the CPU 151 determines whether the data size of the image measured in step S901 meets the designated data size (threshold) of the image. If the measured data size meets the threshold or less (YES in step S902), the process advances to step S903. If the measured data size does not meet the threshold or less (NO in step S902), the process advances to step S904. In step S903, the CPU 151 determines whether the time required for image reproduction processing measured in step S901 meets a predetermined designated threshold. Note that the predetermined threshold is set in accordance with the time intervals at which the respective frames are periodically switched, and is set to, for example, the time equal or less than the time intervals at which the respective frames are periodically switched. If the time required for image reproduction processing is equal to or less than the threshold (YES in step S903), the CPU 151 terminates the processing. If the time required for image reproduction processing exceeds the predetermined threshold (NO in step S902), the process advances to step S905. It is generally known that the larger the data size of an object, the longer the processing time accompanying the processing of expanding vector data into the object. For this reason, in order to inform, in step S904, the user of an object which is the main factor that causes the excess of the upper limit of data size, the CPU 151 measures the processing time accompanying the processing of expanding the vector data into each object in the vector data, and presents the object which takes the longest processing time. Note that if the RAM 153 or the like holds the processing time accompanying the processing of expanding vector data into each object, the CPU 151 may present the object which takes the longest processing time, by referring to the held information. In step S904, the CPU 151 generates an object information table 800 shown in FIG. 4, and presents Background (900 μs) as an object, in the table, which takes the longest processing time accompanying the processing of expanding the vector data into the object. This allows the user to correct the data so as to avoid the data size of an image from exceeding the upper limit by, for example, changing the Background to another object. In step S905, the CPU 151 performs the rasterization processing of converting the vector data representing the presented object into raster data representing the presented object. The process then loops to step S901 to perform similar processing.

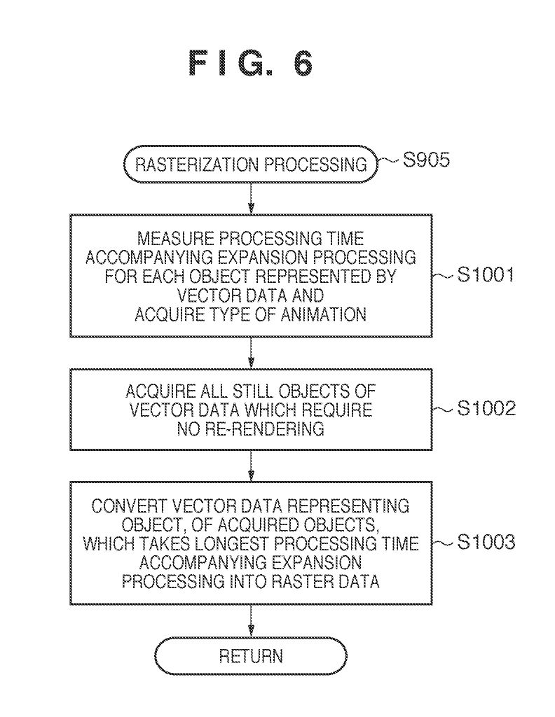

An example of a procedure for rasterization processing (detailed processing in step S905 in FIG. 5) according to this embodiment will be described next with reference to FIG. 6. In step S1001, the CPU 151 measures the processing time accompanying the processing of expanding vector data representing each of a plurality of objects included in an image into an object, and acquires each type of animation. The process then advances to step S1002. In step S1002, the CPU 151 generates the object information table 800 shown in FIG. 4. In step S1002, the CPU 151 acquires all still objects, in the vector data, which need not be re-rendered. The process then advances to step S1003. The still objects correspond to objects which perform no animation in the object information table, and hence the CPU 151 acquires Background 801 and Logo 802 as the still objects.

In step S1003, the CPU 151 converts the vector data representing the object, of the acquired objects, which takes the longest processing time accompanying the processing of expanding the vector data into the object into raster data. The CPU 151 terminates the rasterization processing of converting vector data into raster data. In conversion to raster data, the CPU 151 generates data in a raster format such as BMP, JPEG, or PNG based on vector data representing a target object of a plurality of objects included in an image, replaces a description corresponding to the vector data representing the target object with a description referring to the generated raster data, and holds the resultant data in a storage medium. Note that a raster data format into which conversion is performed can be any format as long as it allows the equipment using the image to render the image. In step S1002, when Background 801 and Logo 802 as objects are acquired, since Background 801 takes the longest processing time (900 μm), accompanying the processing of expanding the vector data into the object, the CPU 151 converts the data into raster data.

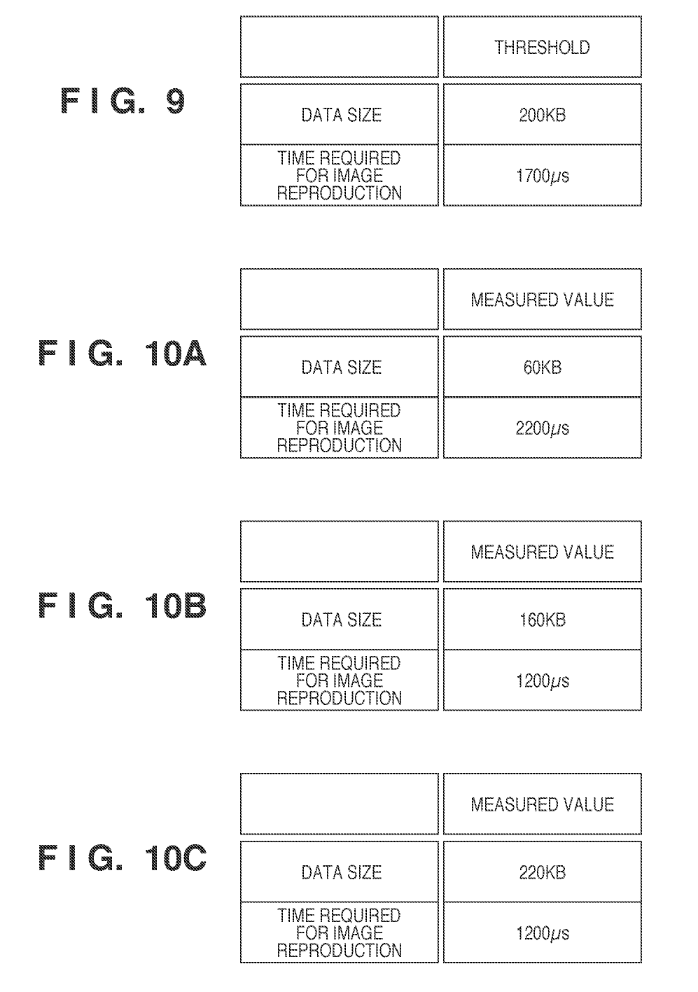

An example of a threshold for the data size of vector data and a threshold for the time required for image reproduction processing using vector data representing each of a plurality of objects constituting an image will be described next with reference to FIG. 9. The user designates these thresholds based on the capacity of the ROM or RAM of equipment which displays an image and a frame rate. The RAM 153 stores the thresholds shown in FIG. 9. An example of the measured values of the data size of vector data and the time required for image reproduction processing using the vector data representing each of a plurality of objects constituting an image will described with reference to FIGS. 10A, 10B, and 10C. The equipment which actually displays an image calculates these values. Note that the equipment may calculate the values by performing simulation based on the specifications of the actual equipment.

A processing procedure in this embodiment will be described next. Assume that a threshold for the data size of vector data and a threshold for the time required for image reproduction processing using vector data representing each of a plurality of objects constituting an image in FIG. 9 are loaded in the RAM 153 in advance. First of all, in step S901, the CPU 151 measures the overall size of vector data and the time required for image reproduction processing using vector data representing each of a plurality of objects constituting an image in an actual equipment environment. As shown in FIG. 10A, the values measured in this case are 60 kB as the data size of the vector data and 2,200 μs as the time required for image reproduction processing using the vector data representing each of a plurality of objects constituting an image. Since the CPU 151 determines in step S902 that the measured data size of the vector data (60 kB) meets the threshold (200 kB), the process shifts to step S903. Since the CPU 151 determines in step S903 that the measured time (2,200 μs) required for image reproduction processing using the vector data representing each of the plurality of objects constituting the image does not meet the threshold (1,500 μs), the process shifts to step S905, that is, step S1001 in FIG. 6. In step S1001, the CPU 151 generates the object information table shown in FIG. 4 based on the vector data representing each of the plurality of objects constituting the image. Upon acquiring Background 801 and Logo 802 as objects in step S1002, the CPU 151 converts Background 801, which takes the longest rendering time, into raster data in step S1003.

When converting Background 801 as an object, the CPU 151 generates, for example, data in a raster format with 130 pixels vertical×120 pixels horizontal from the vector data. The CPU 151 then replaces the rect element with an image element referring to the generated raster data. More specifically, the CPU 151 replaces the portion 202 in FIG. 2 with the following description using an image element: <image id=“Background” x=“−60” y=“−65” width=“120” height=“130”xlink:href=“Background.bmp”>

Note that Background.bmp is a file in a bitmap format generated based on the portion 202.

The process returns to step S901 again to measure the overall size of the image and the rendering time in the actual equipment environment. As shown in FIG. 10B, the measured values in this case are data representing the image, and are 160 kb as the size of data including data designating vector data and raster data and 1,200 μs as the time required for image reproduction processing using vector data representing each of a plurality of objects constituting an image and raster data. Since the CPU 151 determines in step S902 that the measured data size (160 kB) of the data representing the image meets the threshold (200 kB), the process shifts to step S903. Since the CPU 151 determines in step S903 that the measured time (1,200 μs) required for image reproduction processing using the vector data representing each of the plurality of objects constituting the image and the raster data meets the threshold (1,500 μs), the CPU 151 terminates the processing. Assume that in step S901, as shown in FIG. 10C, the measured values are 220 kB as the data size of data representing an image and 1,200 μs as the time required for image reproduction processing using vector data representing each of a plurality of objects constituting the image and raster data. In this case, since the CPU 151 determines in step S902 that the measured data size (220 kB) of the data representing the image does not meet the threshold (200 kB), the process shifts to step S904. In step S904, since the object, in the object information table shown in FIG. 4, which takes the longest time for rendering is Background (900 μs), the CPU 151 presents information indicating that the rendering time of Background is a bottleneck.

As described above, the arrangement according to this embodiment is configured to execute the following processing so as to make the data size of data representing a designated image and the time required for image reproduction processing meet predetermined conditions. That is, this arrangement is configured to preferentially rasterize vector data, of the vector data representing each of a plurality of objects constituting an image, which represents a still object requiring no re-rendering. This makes it possible to process vector data while suppressing an increase in the data size of an image and shortening the time required for image reproduction processing.

Even if it is difficult to meet predetermined conditions, presenting the user an object which takes the longest time for rendering gives him/her useful information for manual conversion of the image.

Although this embodiment has exemplified the processing of converting vector data representing Background into raster data, it is possible to execute the following processing so as to make the time for image reproduction fall within a predetermined threshold. That is, vector data representing a plurality of objects are converted into data in a raster format in advance in descending order of the processing times for objects so as to reduce the number of vector data to be converted into data in the raster format in advance.

### Second Embodiment

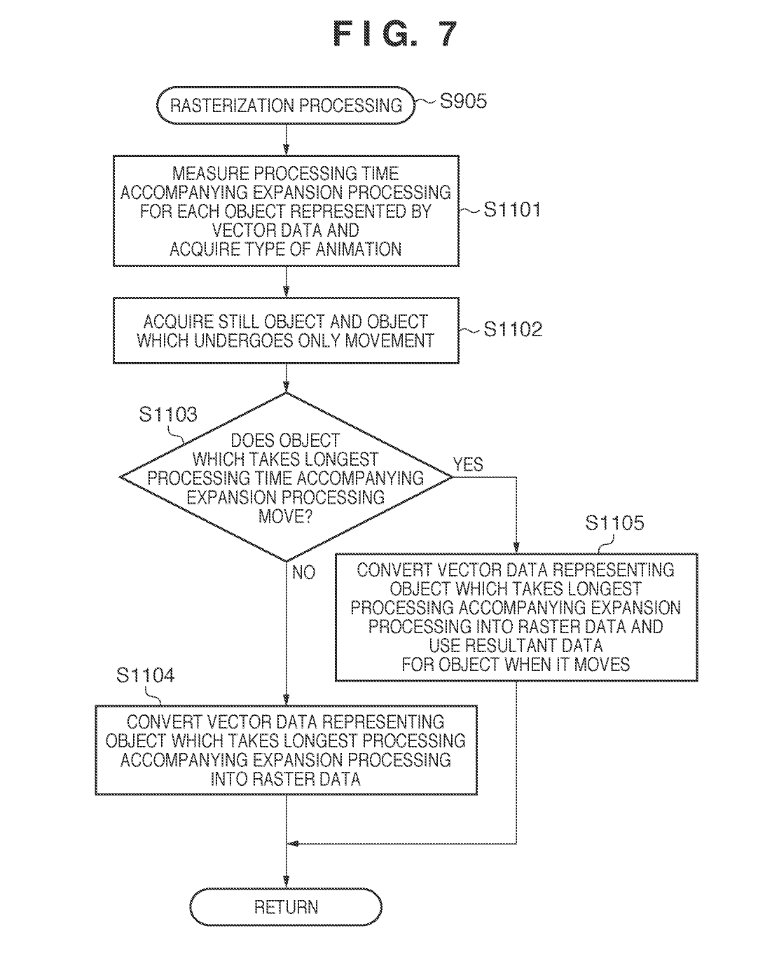

An overall processing procedure according to this embodiment is the same as that shown in FIG. 5 in the first embodiment. An example of a procedure for rasterization processing (step S905) according to the second embodiment will be described with reference to FIG. 7. The processing in step S1101 is the same as that in step S1001 in FIG. 6. In step S1102, this apparatus acquires still objects and objects which undergo only movement based on the object information table generated in step S1101. If the apparatus determines in step S1103 that an object, of the vector data acquired in step S1102, which takes the longest processing time accompanying the processing of expanding the vector data into the object is an object which undergoes movement within the screen (YES in step S1103), the process advances to step S1105. If the object does not move (NO in step S1103), the process advances to step S1104. The processing in step S1104 is the same as that in step S1003 in FIG. 6. In step S1105, as in step S1003, the picture in which the object acquired in step S1103 remains still is converted into raster data and replaced with data in a vector format. Note that when this object moves, the same raster data is used.

In this case, a description of the movement is expressed by using a description in a vector format. The above operation will be described by taking the object information table 800 in FIG. 4 as an example. Referring to FIG. 4, Background, Logo, Icon2, Icon3, and Icon4 are acquired as still objects and objects which undergo only movement. While the time taken to reproduce the image constituted by these objects does not meet a predetermined threshold, vector data are converted into raster data in descending order of the processing times accompanying the processing of expanding the vector data into objects. That is, the vector data are converted in the order of Background (900 μs), Icon3 (230 μs), Icon4 (215 μs), Icon2 (210 μs), and Logo (100 μs).

As described above, the arrangement according to this embodiment is configured to convert vector data representing objects into raster data so as to meet the designated data sizes of the vector data and the designated times taken for image reproduction. This can therefore suppress an increase in the data size of an image and shorten the time taken for image reproduction. In addition, the embodiment can convert an object which moves into raster data for which an increase in data amount is suppressed. Furthermore, it is possible to suppress an increase in data size by using the same raster image for a moving object before, during, and after animation.

### Third Embodiment

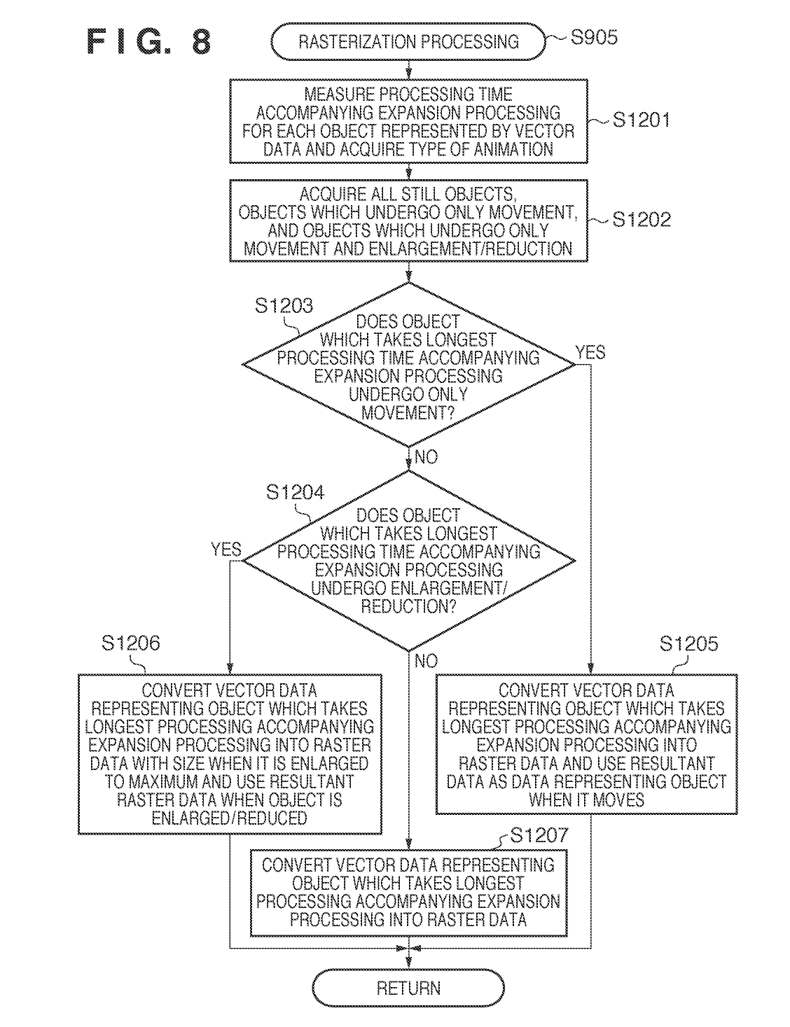

An overall processing procedure according to this embodiment is the same as that shown in FIG. 5 in the first embodiment. An example of a procedure for rasterization processing according to this embodiment will be described with reference to FIG. 8. The processing in step S1201 is the same as that in step S1001 in FIG. 6. In step S1202, this apparatus acquires still objects, objects which undergo only movement, and objects which undergo only movement and enlargement/reduction based on an object information table 800 generated in step S1201. If the apparatus determines in step S1203 that an object, of the vector data acquired in step S1202, which takes the longest processing time accompanying the processing of expanding the vector data into the object is an object which undergoes only movement within the screen, based on the animation information of the object, (YES in step S1203), the process advances to step S1205. Otherwise (NO in step S1203), the process advances to step S1204. If the apparatus determines in step S1204 that an object which takes the longest processing time accompanying the processing of expanding the vector data into the object is an object which is enlarged/reduced within the screen, based on the animation information of the object, (YES in step S1204), the process advances to step S1206. Otherwise (NO in step S1203), the process advances to step S1207.

The processing in step S1205 is the same as that in step S1105 in FIG. 7. In step S1206, as in step S1104, the picture in which the object acquired in step S1202 remains still is converted into raster data and replaced with a description in a vector format. That is, the apparatus converts the object which takes the longest processing time accompanying the processing of expanding the vector data into the object into raster data with the size set when the object is enlarged to the maximum, and uses the resultant raster data for the object when it is enlarged/reduced. That is, the same raster data is used when the object is enlarged/reduced.

The resolution of raster data is set to the level that maintains sufficient sharpness when the object is enlarged to the maximum data size in the animation mode. In addition, a description of an animation is expressed by using a description in a vector format. The processing in step S1207 is the same as that in step S1104.

The above operation will be described by taking the object information table 800 in FIG. 4 as an example. Referring to FIG. 4, Background, Logo, Icon1, Icon2, Icon3, and Icon4 are acquired as still objects, objects which undergo only movement, and objects which undergo only movement and enlargement/reduction. While the time taken to reproduce the image does not meet a predetermined threshold, the vector data of these objects are converted into raster data in descending order of the processing times accompanying the processing of expanding the vector data into objects. That is, the vector data are converted in the order of Background (900 μs), Icon3 (230 μs), Icon1 (220 μs), Icon4 (215 μs), Icon2 (210 μs), and Logo (100 μs).

As described above, the arrangement according to this embodiment is configured to convert vector data into raster data so as to make the data size representing an image and the time taken for image reproduction meet predetermined conditions. This makes it possible to suppress an increase in data size and shorten the rendering time. In addition, this embodiment can convert an object which undergoes movement and enlargement/reduction into raster data with a small data amount. Note that when converting an object which undergoes enlargement/reduction into raster data, the embodiment converts the object into raster data with a size set when it is enlarged to the maximum. This can therefore suppress a degradation in image quality when an object is enlarged/reduced by means of an animation.

According to the present invention, it is possible to efficiently determine data, of vector data representing each of a plurality of objects constituting an image, which is to be converted into raster data in advance.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2010-008473 filed on Jan. 18, 2010 and 2010-261725, filed Nov. 24, 2010, which are hereby incorporated by reference herein in their entirety.

What is claimed is:

1. An information processing apparatus which processes vector data representing each of a plurality of objects constituting an image, the apparatus comprising:
an acquisition unit adapted to acquire a processing time for processing including processing of expanding the vector data into each of the objects;
a specifying unit adapted to specify a time taken to reproduce the image by using the vector data representing each of the plurality of objects, based on the processing time acquired by said acquisition unit; and
a determination unit adapted to determine, when the time specified by said specifying unit exceeds a predetermined threshold, data, of the vector data representing the plurality of objects, which is to be converted into data in a raster format in advance, based on each processing time acquired by said acquisition unit, the time specified by said specifying unit, and the predetermined threshold.

2. The apparatus according to claim 1, wherein said acquisition unit acquires, as the processing time, a time between the instant at which the vector data is read and the instant at which an object is converted into a state which is configured to be displayed on a display unit.

3. The apparatus according to claim 1, wherein said acquisition unit acquires, as the processing time, a time between the instant at which the vector data is read and the instant at which an object is converted into a state which is configured to be displayed at a set position on a display unit.

4. The apparatus according to claim 1, wherein said acquisition unit acquires, as the processing time, a maximum time between the instant at which the vector data is read and the instant at which an object is converted into a state which is configured to be displayed at a set position on a display unit.

5. The apparatus according to claim 1, wherein said acquisition unit acquires, as the time taken for reproduction, a time between the instant at which the vector data representing the plurality of objects constituting the image is read and the instant at which the objects are converted into states which are configured to be displayed at predetermined positions on a display unit with predetermined sizes.

6. The apparatus according to claim 1, wherein said determination unit determines data, of the vector data representing the plurality of objects, which is to be converted into data in a raster format in advance so as to make the time taken for reproduction fall within the predetermined threshold and reduce the number of vector data to be converted into data in the raster format in advance.

7. The apparatus according to claim 6, wherein said determination unit determines data, of the vector data representing the plurality of objects, which are to be converted into data in the raster format in advance, in descending order of the processing times for the objects.

8. The apparatus according to claim 6, wherein said determination unit determines data, of at least part of the vector data representing the plurality of objects, which are to be converted into data in the raster format in advance, in descending order of the processing times for the objects.

9. The apparatus according to claim 1, further comprising a generating unit adapted to generate data constituting the data representing the image from data in the raster format converted from the vector data determined by said determination unit and vector data which is not determined by said determination unit, and a holding unit adapted to hold the data generated by said generating unit.

10. A method of operating an information processing apparatus which processes vector data representing each of a plurality of objects constituting an image, the method comprising:
acquiring a processing time for processing including processing of expanding the vector data into each of the objects;
specifying a time taken to reproduce the image by using the vector data representing each of the plurality of objects, based on the processing time acquired in the acquiring; and
determining, when the time specified in the specifying exceeds a predetermined threshold, data, of the vector data representing the plurality of objects, which is to be converted into data in a raster format in advance, based on each processing time acquired in the acquiring, the time specified in the specifying, and the predetermined threshold.

11. A computer-readable storage medium storing a computer program for causing a computer to execute steps in a method of operating an information processing apparatus defined in claim 10.
